(19) United States
(12) Patent Application Publication
(10) Pub. No.: US 2015/0128034 A1
(43) Pub. Date: May 7, 2015

(54) ACHIEVING BETTER CASE OUTCOMES THROUGH THE USE OF AGGREGATE CASE HISTORIES

(71) Applicant: International Business Machines Corporation, Armonk, NY (US)

(72) Inventors: FRANCISCO CURBERA, Hastings on Hudson, NY (US); Matthew J. Duftler, Mahopac, NY (US); Geetika T. Lakshmanan, Winchester, MA (US); Nirmal K. Mukhi, Ramsey, NJ (US); Szabolcs Rozsnyai, New York, NY (US); Aleksander A. Slominski, Riverdale, NY (US)

(73) Assignee: International Business Machines Corporation, Armonk, NY (US)

(21) Appl. No.: 14/219,593

(22) Filed: Mar. 19, 2014

Related U.S. Application Data
(60) Provisional application No. 61/898,576, filed on Nov. 1, 2013.

(51) Int. Cl. G06F 17/21

(52) U.S. Cl. CPC G06F 17/211
USPC 715/273

(57) ABSTRACT

A method of case management includes receiving a plurality of previously executed case instances, receiving a selection of current case attributes and at least one candidate case outcome during runtime of a currently executing case instance, and generating a visual representation of case distributions using the previously executed case instances. The visual representation depicts a correlation between the current case attributes and the at least one candidate case outcome, and is generated using analytics applied to the plurality of previously executed case instances.

### CROSS-REFERENCE TO RELATED APPLICATIONS

This application claims priority to and the benefit of Provisional Application Ser. No. 61/898,576, filed on Nov. 1, 2013, the disclosure of which is incorporated by reference herein in its entirety.

### BACKGROUND

1. Technical Field

Exemplary embodiments of the present invention relate to case management history and analytics, and more particularly, to generating visual representations providing insight for a current case in a case management system.

2. Discussion of Related Art

Case management systems provide a way to create, model and analyze cases. In a case management system, individuals can run instances of a case model. A case model includes a set of tasks. Each task can invoke a workflow of work items or steps. A workflow is an execution sequence including rules on steps that govern the order in which the steps may execute. Case instances in a case management system are non-deterministic, meaning that they have one or more points where different decisions may be made, which may result in different outcomes. They are driven more by human decision making and document content status than by other factors. For example, case workers working on different cases may make different decisions and arrive at different outcomes based on different characteristics (e.g., case attributes) in the different cases. Knowledge of the decisions made and the outcomes reached in previously completed case instances, similar cases may aid a current case worker working on a current case instance.

### SUMMARY

According to an exemplary embodiment of the present invention, a method of case management includes receiving a plurality of previously executed case instances, receiving a selection of current case attributes and at least one candidate case outcome during runtime of a currently executing case instance, and generating a visual representation of case distributions using the previously executed case instances. The visual representation depicts a correlation between the current case attributes and the at least one candidate case outcome, and the visual representation is generated using analytics applied to the plurality of previously executed case instances.

In an exemplary embodiment, the method further includes extracting results from a user interaction with the visual representation, and applying the results to support execution of the currently executing case instance and future case instances.

In an exemplary embodiment, the selection of the current case attributes is dynamically changed during runtime of the currently executing case instance, and in response, the visual representation is automatically updated during runtime.

In an exemplary embodiment, the selection of the at least one candidate case outcome is dynamically changed during runtime of the currently executing case instance, and in response, the visual representation is automatically updated during runtime.

In an exemplary embodiment, the visual representation includes a plurality of visualizations, and the plurality of visualizations are displayed in an order corresponding to a statistical significance of each of the plurality of visualizations.

In an exemplary embodiment, case attributes included in the currently executing case instance are highlighted in the visual representation.

In an exemplary embodiment, case attributes that are not included in the currently executing case instance are hidden in the visual representation.

In an exemplary embodiment, the method further includes pre-selecting the current case attributes based on the selected candidate outcome.

In an exemplary embodiment, the method further includes extracting a set of rules based on a user interaction with the visual representation, and implementing the set of rules to govern a manner in which steps invoked by a given task executes in a case model.

In an exemplary embodiment, the method further includes determining an activity present in each of the plurality of previously executed case instances for which the visual representation has been previously determined to be useful, and generating an alert during execution of a future case instance indicating that the visual representation has been previously determined to be useful at the determined activity, upon the determined activity being executed in the future case instance.

In an exemplary embodiment, the visual representation includes an indication of user input generated during the plurality of previously executed case instances.

In an exemplary embodiment, the user input includes a user ranking indicating usefulness of a corresponding case attribute, or a user comment relating to the corresponding case attribute.

In an exemplary embodiment, the visual representation is dynamically generated during runtime of the currently executing case instance.

According to an exemplary embodiment of the present invention, a method of case management includes receiving a plurality of previously executed case instances, receiving a selection of a selected activity of a currently executing case instance, and generating a visual representation including an aggregate timeline using the plurality of previously executed case instances. The visual representation depicts a sequence of a plurality of activities included in the plurality of previously executed case instances in time order, a first activity of the plurality of activities is the selected activity, and a last activity of the plurality of activities is a case outcome.

In an exemplary embodiment, the method further includes extracting results from a user interaction with the visual representation, and applying the results to support execution of the currently executing case instance and future case instances.

In an exemplary embodiment, the selection of the selected activity is dynamically changed during runtime of the currently executing case instance.

In an exemplary embodiment, each of the plurality of activities depicts at least one of a minimum time to completion, a maximum time to completion, an average time to completion, an average start time, an average end time, and a median time to completion of the corresponding activity.

In an exemplary embodiment, each of the plurality of activities depicts at least one of a frequency of execution in a set of traces, a next activity or sub-activity to be executed, and an outcome determined to be highly correlated with the corresponding activity.

In an exemplary embodiment, the method further includes computing a normalized average start time for each of the plurality of activities with respect to a start time of the currently executing case instance, and ordering the plurality of activities based on the normalized average start times.

### BRIEF DESCRIPTION OF THE DRAWINGS

The above and other features of the present invention will become more apparent by describing in detail exemplary embodiments thereof with reference to the accompanying drawings, in which:

FIG. 1 shows an exemplary graphical user interface (GUI) used for achieving better case outcomes through the use of aggregate case histories, according to an exemplary embodiment of the present invention.

FIG. 2 shows an exemplary visual representation embodying histograms, according to an exemplary embodiment of the present invention.

FIG. 3 shows an exemplary case model including a plurality of tasks, according to an exemplary embodiment of the present invention.

FIG. 4 shows an exemplary visual representation showing an aggregate timeline view, according to an exemplary embodiment of the present invention.

FIG. 5 shows an exemplary visual representation showing an aggregate timeline view providing information relating to the activities involved in reaching a case outcome with reference to the case model of FIG. 3, according to an exemplary embodiment of the present invention.

FIG. 6 illustrates a computer system for implementing aspects of exemplary embodiments of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

Case management systems provide a way to create, model and analyze cases. In a case management system, individuals can run instances of a case model. Exemplary embodiments of the present invention provide a system and method that allow a case worker to utilize aggregate information relating to past cases to arrive at an appropriate outcome in a current case. By leveraging aggregate information relating to past cases that are similar to a current case, a case worker may be able to understand past behaviors that have historically resulted in better outcomes, and use this information to arrive at a better outcome in the current case. Case workers may refer to, for example, knowledge workers, case managers, case supervisors, etc. Herein, the terms case worker, knowledge worker, case manager, case supervisor, and worker may be used interchangeably.

Exemplary embodiments of the present invention are directed to generating visual representations providing insight for a current case in a case management system including, for example, visual representations indicating a correlation of case attributes with case outcomes, and visual representations showing an aggregate timeline providing information relating to the activities involved in reaching a case outcome. The visual representations may be generated during runtime of a currently executed case instance, and may be dynamically generated at any point during the execution of a case instance. These visualizations are computed on the basis of previously executed completed case instances (e.g., using analytics applied to the plurality of previously executed case instances), allowing the worker working on a currently executing case instance to view the correlation of one or more attributes of a currently executing case instance with one or more case outcomes of previously executed cases. The currently executing case instance may be referred to herein as the current case, and the worker working on the currently executed case instance may be referred to herein as the current worker. Generation of the visual representation allows for a current case worker to extract results based on his or her interaction with the visual representation, and apply the results to support execution of the currently executing case instance, as well as future case instances.

In an exemplary embodiment of the present invention, a visual analytics tool is provided. The visual analytics tool receives completed case instances as input, and generates and outputs a visual representation. The visual analytics tool may include, for example, a graphical user interface (GUI) allowing a user to interact with the visual analytics tool, an input/output (I/O) interface allowing for data to be input to and output from the visual analytics tool, a database allowing for the storage of data, and a processor allowing for the generation of visual representations using the data received by and/or stored within the visual analytics tool, as described herein. The completed case instances received as input are previously executed case instances. The visual representation is generated and output using analytics applied to aggregate historical case information. The visual representation indicates correlations between case attributes and case outcomes. As used herein, the term correlation refers to any type of statistical relationship involving dependence (e.g., dependence of a case outcome on case attributes), and the term aggregate historical case information may refer to a plurality of previously executed case instances that have already been completed. In exemplary embodiments, statistical analysis may be performed to determine the degree and statistical significance of the correlation of the attributes and outcomes. In some embodiments, the visual representation may depict only statistically significant correlations, and the depiction of insignificant correlations may be hidden and only displayed at the user's request.

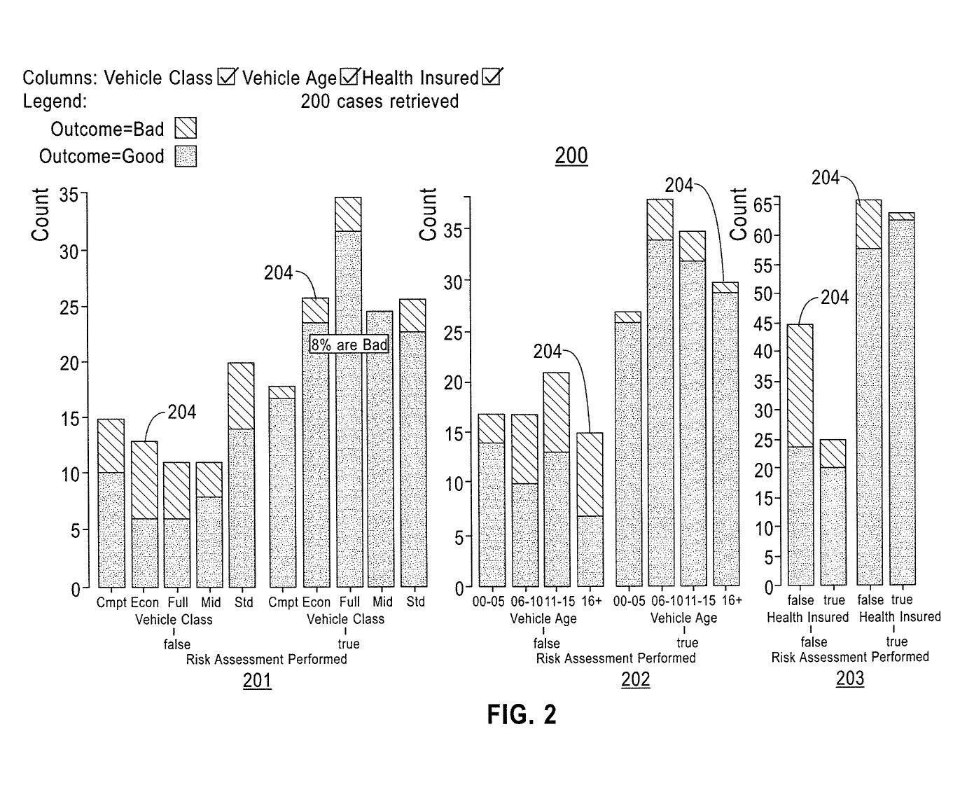

The visual representation may also include, for example, indications of rankings (e.g., based on perceived usefulness) and comments from workers that have previously contributed information used to generate the visual representation. For example, in an exemplary embodiment, the worker may rank the visual representation in terms of its helpfulness using a predetermined scale, for example 1-10, where 1 indicates that the visual representation was not helpful at all, and 10 indicates that the visual representation was extremely helpful. The worker may further add some comments and save them with respect to the visual analytics tool and also reference the dataset on which the visual analytics tool was run. When another case worker working on a different case instance uses the visual analytics tool, he or she can have access to the comments and ranking information saved by other case workers about the tool. A worker working on a current case may make the final decision for a current case based on the insight attained from the generated visual representation. As described below with reference to FIG. 2, a visual representation may include a plurality of visualizations. In exemplary embodiments, indications of rankings and comments may be provided for each of the plurality of visualizations within a visual representation.

In an exemplary embodiment, the context within which a given visual representation is found useful may be learned over time. For example, during an executing case instance, the step (e.g., the activity) at which the visual analytics tool is invoked for situations in which the tool is ranked highly and positive comments are recorded about the visual representation by a case worker may be recorded. Over a period of time, for a set of completed case instances, the most common step at which a particular visual representation is found useful may be learned. Usefulness may be computed, for example, on the basis of the average ranking of the tool, computed as the average of the rank score assigned to the tool by a set of N case instances. In a future executing case instance, the visual analytics tool may generate an alert when a case worker is executing a particular step, indicating that on average in previous case instances, case workers found a particular visual representation useful in making a decision, and indicate the name of the visual representation, as well as provide a link to generate this particular visual representation.

For convenience of explanation, exemplary embodiments of the present invention are described herein with reference to an example in which a case worker is an insurance policy underwriter and the case management system relates to the issuance of insurance policies. However, it is to be understood that this scenario is merely exemplary, and that the present invention is not limited to being utilized in an insurance scenario. Rather, exemplary embodiments of the present invention may be utilized in any case management scenario. Additional exemplary case management scenarios include case management relating to, but not limited to, healthcare banking, government, general businesses, etc.

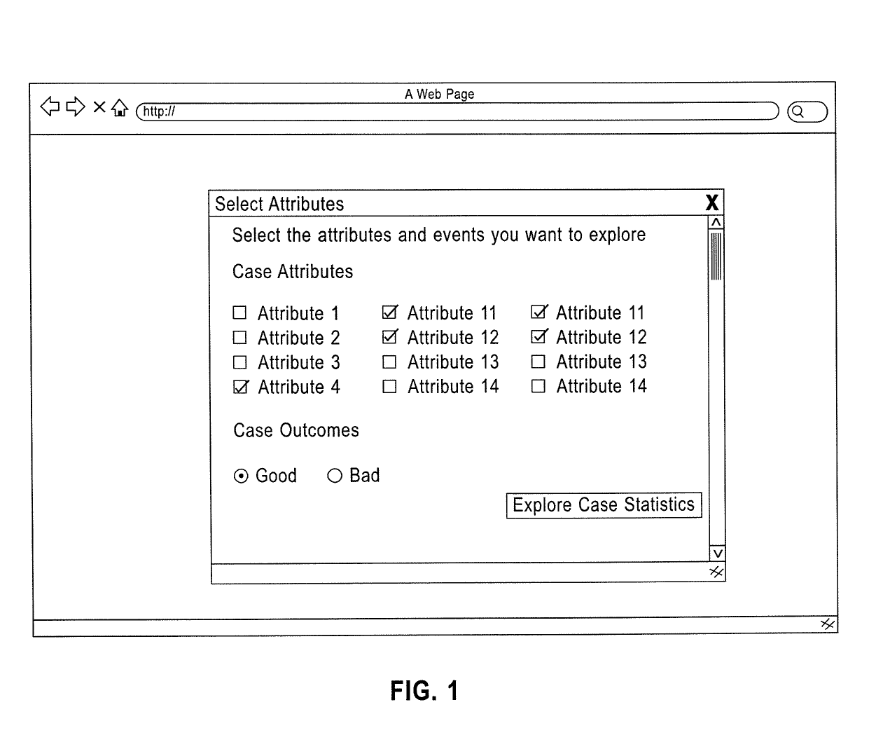

A case worker currently working on a case may be tasked with making a decision during execution of the case. For example, an insurance policy underwriter (e.g., a case worker) may be tasked with deciding whether risk assessment should be performed for an applicant in a current insurance case in which the case office is Chicago, and in which the total insured amount is $75,000. Exemplary embodiments of the present invention provide a visual analytics tool to the case worker having an aggregate history correlation option that may be selected by the case worker. For example, in an exemplary graphical user interface (GUI), the case worker may be presented with an “Explore Alternatives” button that may be selected. Upon choosing to utilize the aggregate history correlation option, the worker is presented with a selection screen in which the worker may select from a set of attributes, as shown in FIG. 1. For example, the worker may select attributes deemed relevant for the current case. In addition, the selection screen allows the worker to choose a candidate outcome(s) (e.g., a task or a work item in the case). For example, the candidate outcomes in an insurance setting may include “Customer Default”, “Loan Cancellation” and “Loan Rejection.” Further, outcomes may be pre-classified into a smaller number of broad categories, for example, by a case supervisor or case worker. For example, a plurality of different outcomes may be pre-classified as being either “Good” or “Bad”, as shown in the example illustrated in FIG. 1. Rather than displaying a large number of specific outcomes, the pre-classified broad outcomes may be displayed to the current case worker for selection.

Case attributes represent data that has impacted the previous related cases that correspond to the aggregate historical case information. In the current example, for convenience of explanation, FIG. 1 includes a general listing of attributes (e.g., Attribute 1, Attribute 2, etc.). Actual attributes for the current example may include, for example, date of birth, gender, address, previous accident history, type of vehicle being insured, vehicle history, vehicle class, completion time, number of cars insured, number of motorcycles insured, total items insured, total amount insured, agent name, office name, referral requirement, premium amount, liability amount, rejection reason, case health, etc.

Exemplary embodiments provide a variety of options relating to the selection and availability of different case attributes. For example, the case worker may explicitly select attributes to be included during case execution (e.g., by manually selecting and deselecting different attributes via the GUI, as shown in FIG. 1). In addition, attributes may be automatically pre-selected based on the selected candidate outcome. For example, in an exemplary embodiment, a case supervisor may pre-select certain attributes for different candidate outcomes. When the current case worker selects a candidate outcome, these pre-selected attributes are automatically utilized when generating the visual representation. The pre-selected attributes may be supplemented by the attributes explicitly selected by the current worker, or in exemplary embodiments, may override the explicitly selected attributes. In addition, the set of attributes and outcomes driving the visual representations may be selected by the case model designer (e.g., a case supervisor or another case worker) during design time of the case model. For example, since the case designer would generally have a deep understanding of the case and the industry to which the case belongs, the case designer may mark attributes in the case model (e.g., case properties) as important in terms of driving the visual representation provided by the visual analytics tool during runtime.

In exemplary embodiments, the current worker may not be presented with an option to explicitly select attributes. Rather, the current worker may only be presented with an option to select a candidate outcome(s), and the attributes may be automatically pre-selected based on the selected candidate outcome.

In addition to the current worker explicitly selecting attributes during case execution and a case model designer preselecting attributes prior to case execution, predictive analytics may be used to be trained on a set of historical execution traces of cases, and automatically select attributes that are highly correlated with the selected candidate outcome. Predictive analytics such as, for example, a decision tree, may be trained on a completed set of case instances to determine the correlation between a set of attributes and a given outcome. If the correlation is found to be statistically significant, these attributes and outcomes may be suggested to the case worker to drive the visual representation during runtime. Such predictive analytics may be performed offline, prior to making the visual analytics tools available to case workers during runtime of the current case.

Further, exemplary embodiments may utilize a filtering process to determine the attributes that exist for the completed cases corresponding to the aggregate historical case information, and these attributes may be automatically selected, or suggested to the current case worker. Using this filtering process, attributes that are present in the aggregate historical case information may be selected in a first pass, and any attributes selected in the first pass that are not present in the current case may be filtered out in a second pass. As a result, the generated visual representation may include only relevant attributes that are in common between the past completed cases and the current case. Once the case attributes and the candidate outcome have been selected, the visual representation is generated. Further, in an exemplary embodiment, the case attributes and candidate outcome selections may be saved and re-used as default selections for future case workers in similar scenarios. As described above, generation of the visual representation is based on analytics applied to aggregate historical case information and the selected case attributes and candidate outcome. The visual representation indicates correlations among the selected attributes and candidate outcome(s) over a set of historical executions of the case. That is, the visual representation illustrates the distribution of the selected case attributes by the task outcome options (e.g., in the current example, whether risk assessment is required), showing the number of cases with a given attribute value for each outcome.

An exemplary visual representation 200 is shown in FIG. 2. In FIG. 2, the visual representation 200 is embodied as a plurality of histograms in which the x-axis corresponds to case attributes, the y-axis corresponds to the decision being made (e.g., in the current example, whether risk assessment should be performed), and each bar proportionally indicates the occurrence of a good outcome versus a bad outcome. It is to be understood that the visual representation according to exemplary embodiments is not limited to a plurality of histograms. Rather, the visual representation may be any type of visual representation indicating a correlation between case attributes and case outcomes relating to a decision to be made by a case worker.

A visual representation may include a plurality of visualizations. For example, in FIG. 2, the visual representation 200 includes three visualizations 201, 202 and 203. Different visualizations within a visual representation correspond to different case attributes correlated to the decision being made. That is, different visualizations within a visual representation indicate the correlation between different case attributes and past outcomes in relation to the current decision to be made (e.g., whether risk assessment should be performed in the current case). For example, referring to FIG. 2, the visual representation 200 includes a first visualization 201 indicating the relationship between vehicle class and an acceptable outcome relative to risk assessment, a second visualization 202 indicating the relationship between vehicle age and an acceptable outcome relative to risk assessment, and a third visualization 203 indicating the correlation between whether the person seeking auto insurance has health insurance and an acceptable outcome relative to risk assessment.

Each visualization 201, 202 and 203 in the visual representation 200 of FIG. 2 includes two portions—a first portion showing data corresponding to risk assessment not being performed (e.g., Risk Assessment Performed=false), and a second portion showing data corresponding to risk assessment being performed (e.g., Risk Assessment Performed=true). The current worker may use the information presented in the visual representation 200 to decide whether risk assessment should be performed in the current case, and may save and store the visual representation 200 for later use. When saved and stored, future case workers that are tasked with the same decision point in another case may retrieve the stored visual representation 200, and may further update the visual representation 200, as well as add comments to and tag the visual representation 200.

Tagging and commenting on visual representations allows for the extraction of management set of rules in exemplary embodiments of the present invention. Consider the above example relating to a case worker deciding whether risk assessment should be performed for a current case. Once the case worker has used the visual representation 200 to arrive at a decision, the case worker may provide input that is linked to the visual representation (or one of the specific visualizations of the visual representation). This input may include, for example, a comment, a tag, or a ranking (e.g., a ranking score indicating helpfulness relative to other available candidate outcomes and/or case attributes), and may indicate how useful different analytics (e.g., candidate outcomes and/or case attributes) were in gaining insight to making the decision. For example, the case worker may provide input indicating that vehicle class and vehicle age are the most helpful case attributes when arriving at the risk assessment decision (e.g., vehicle class and vehicle age are most highly correlated with risk assessment), and that vehicle age was a more helpful case attribute than whether the person seeking auto insurance has health insurance in arriving at the risk assessment decision (e.g., vehicle age is more correlated with risk assessment than health insurance status). As a large number of case workers interested in the same decision provide this input in different cases, training may be performed to determine which analytics (e.g., which candidate outcomes and/or case attributes) most frequently receive input indicating that they have a high degree of helpfulness (e.g., which analytics are the most correlated with the current decision). For example, training may be performed to arrive at a set of rules by analyzing a certain number of cases to determine that vehicle class and vehicle age are the most highly correlated case attributes and that health insurance status is the least correlated case attribute relative to risk assessment. These rules may be used to automate the process of generating visual representations. For example, management set of rules may be used to pre-select certain case attributes and/or candidate outcomes to be used when generating visual representations for certain decisions.

In an example, assume that a case worker decides to execute risk assessment for a current case he or she is handling in response to the insight gained from the visual analytics present in a generated visual representation. Based on the characteristics of the case instances in which case workers do this, a rule may be constructed. For example, the rule may be to always perform risk assessment if a vehicle class is “Economy.” This rule may then be implemented in the workflow logic governing work items for a given task in the case model. That is, the rule(s) may be implemented to govern the manner in which work items invoked by a given task executes in a case model. In general, rules may be learned from the way case workers interact with the case management system in response to the insight they gain from the visual analytics depicted in a visual representation, and these rules may be implemented as part of the case model logic as part of a future iteration of the case model that may be used to drive future case instances.

Case attributes corresponding to the current case instance may be highlighted in a visual representation. For example, in FIG. 2, case attributes corresponding to the current case instance include dark outlines 204 indicating to the current worker that these attributes correspond to the current case instance.

In an exemplary embodiment of the present invention, a visual representation is generated and output using analytics applied to aggregate historical case information. The visual representation shows an aggregate timeline view providing information relating to the activities involved in reaching a case outcome.

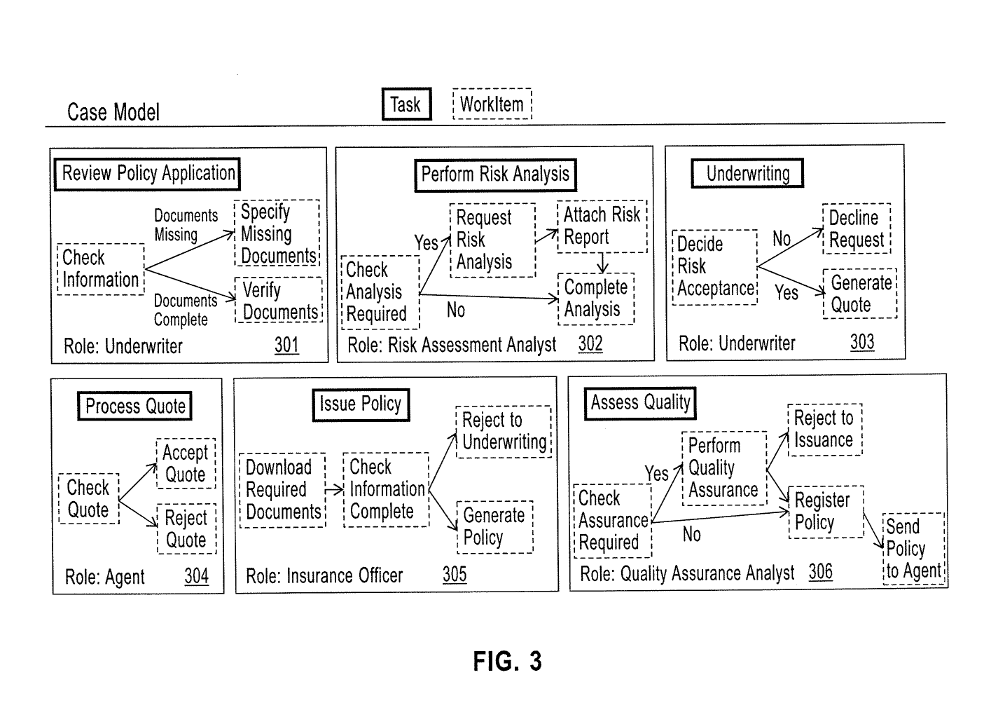

FIG. 3 shows an exemplary case model including a plurality of tasks.

A case model in a case management system includes a plurality of tasks that may be executed when executing a case instance. A case instance refers to one running instance of a case. For example, referring to the example described above, a currently executed insurance policy review application process is a case instance. A task may have a set of pre-conditions that results in the task executing when certain conditions are met. The tasks in the case model may be executed in different orders in different case instances. Each task includes at least one work item (e.g., step), which may also be referred to as a sub-task. The work items in a task may be tied together in a workflow and may have a determined execution order. When a task is executed, the work items within the task are invoked. As described above, the work items are invoked in a certain order, which is referred to as a workflow. Each task may be performed by a worker serving a different role (e.g., an underwriter, a risk assessment analyst, an agent, an issuance officer, or a quality assurance analyst).

Referring to the case model shown in FIG. 3, which corresponds to the example described herein relating to the issuance of an insurance policy, the plurality of tasks include a “Review Policy Application” task 301, a “Perform Risk Analysis” task 302, an “Underwriting” task 303, a “Process Quote” task 304, an “Issue Policy” task 305, and an “Assess Quality” task 306. In FIG. 3, the tasks are represented by solid lines and the work items within the tasks are represented by dotted lines. The workflow of each of the tasks shown in FIG. 3 will be described below.

Referring to the “Review Policy Application” task 301, when this task is executed, the policy application information is checked. If the information is complete, documents including the information are verified. If this information is not complete, the missing document(s) are specified and the workflow is repeated until the documents are verified. Once the documents are verified, the “Review Policy Application” task status is set to true, and the “Perform Risk Analysis” task 302 is performed.

Referring to the “Perform Risk Analysis” task 302, when the task is executed, it is determined whether risk analysis is required. If risk analysis is not required, the task is completed. If risk analysis is required, risk analysis is requested, the corresponding risk report is attached, and the analysis is completed. Once the analysis is completed, the “Perform Risk Analysis” task status is set to true, and the “Underwriting” task 303 is performed.

Referring to the “Underwriting” task 303, when the task is executed, it is determined whether the policy should be accepted in light of the performed risk analysis. If the risk is not to be accepted, the insurance request is declined. If the risk is to be accepted, a quote is generated. If a quote is generated, the “Underwriting” task status is set to true, and the “Process Quote” task 304 is performed.

Referring to the “Process Quote” task 304, when the task is executed, the quote is checked, and is either accepted or rejected. If the quote is accepted, the “Process Quote” task status is set to true, and the “Issue Policy” task 305 is performed.

Referring to the “Issue Policy” task 305, when the task is executed (e.g., when a quote is accepted), the required documents are downloaded and are checked for completion. If the information is incomplete, the policy is not issued, the “Issue Policy” task status is set to false, and the “Underwriting” task 303 is executed. If the information is complete, the policy is generated and issued, the “Issue Policy” task status is set to true, and the “Assess Quality” task 306 is performed.

Referring to the “Assess Quality” task 306, it is first determined whether quality assurance is required. If quality assurance is not required, the policy is sent to the appropriate worker (e.g., an insurance agent). If quality assurance is required, quality assurance is performed. If quality assurance fails, the policy is rejected, and the “Issue Policy” task 305 is executed. If quality assurance passes, the policy is registered, and the policy is sent to the appropriate worker (e.g., an insurance agent).

A case instance includes an execution of a case model in which one or more tasks and their corresponding work items are executed. In exemplary embodiments, a timeline of a single case represents a sequence of work items, tasks, or work items together with their associated tasks, executed over a period of time for a given case instance. The generated visual representation may include an aggregate timeline computed from a set of case instances. The aggregate timeline may show the execution order, the average execution duration for each work item, and each work item's corresponding task, computed from a set of case instances. The aggregate timeline allows a current worker to perform investigative analysis such as, for example, determining the number of case instances for which a particular work item was executed, determining the outcome of a set of cases in which a particular work item was executed, or determining the typical pattern of execution of a set of case instances by viewing them in the aggregate timeline. For example, if there is a loop between two separate tasks that always occurs, this pattern may be identified in the aggregate timeline.

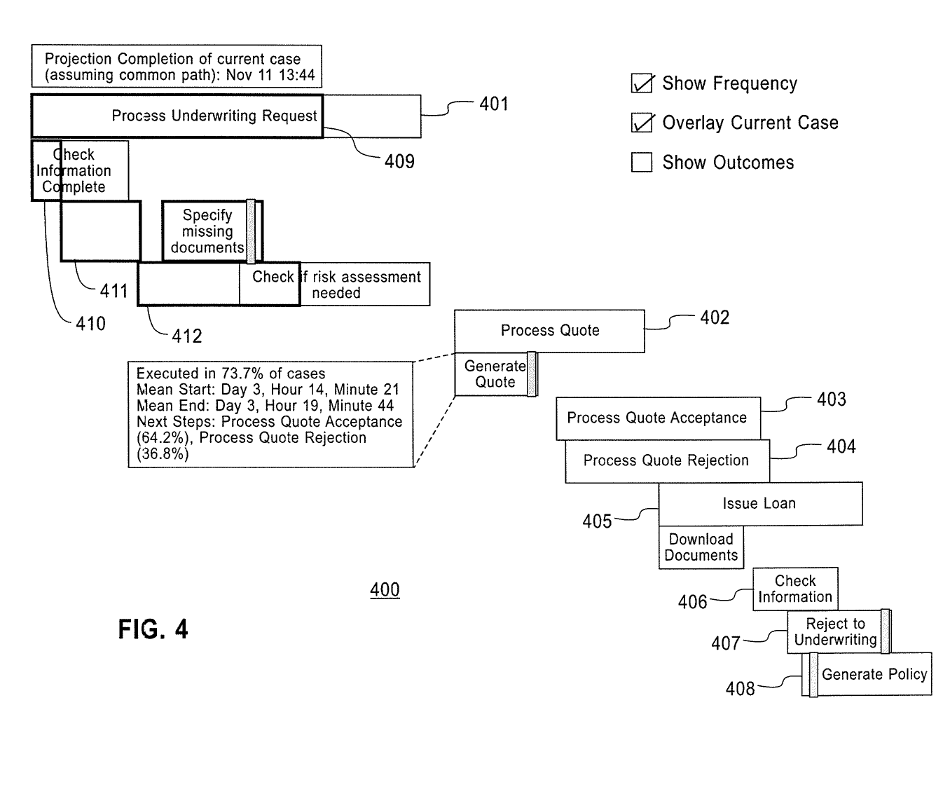

FIG. 4 shows an exemplary visual representation showing an aggregate timeline view, according to an exemplary embodiment of the present invention.

Referring to FIG. 4, in an exemplary embodiment, the generated visual representation 400 shows an aggregate timeline view providing information relating to the activities involved in reaching a case outcome. The visual representation 400 spans a set of previously completed case instances, and shows the activities performed in these case instances in time order along a horizontal axis. That is, the visual representation 400 reflects an aggregation of a plurality of previously completed cases. For example, if the visual representation 400 is based on 100 completed cases, the visual representation 400 may be described as reflecting 100 customers that previously applied for an insurance policy. The first activity in the visual representation 400 is the activity selected by the current worker (e.g., the worker may choose any activity in a case model as the first activity to be displayed), and the last activity in the visual representation 400 is the case outcome. The visual representation 400 shows the sequence of all activities occurring between the first activity and the case outcome, and the duration of all of the activities. The activities may be ordered by start time. For example, the normalized average (e.g., mean) start time for each activity may be computed with respect to the case instance start time, and all case instances may be assumed to start at time 0. Thus, in an exemplary embodiment, the activities may be ordered by this normalized average (e.g., mean) start time. For example, in FIG. 4, the visual representation 400 begins with a “Process Underwriting” activity 401 and ends with a “Generate Policy” activity 408, and includes the “Process Quote” activity 402, “Process Quote Acceptance” activity 403, “Process Quote Rejection” activity 404, “Issue Loan” activity 405, “Check Information” activity 406, and “Reject to Underwriting” activity 407 therebetween.

Each activity indicates a start time of the activity, an end time of the activity, and an average (e.g., mean) time of the activity. For example, the x-axis includes a timescale based on a particular unit. For example, the timescale may begin at hour 0 and show increments in minutes. The inclusion of the timescale allows a current worker to determine the start, end, and average (e.g., mean) time of each activity. Each activity may include one or more sub-activities. For example, in FIG. 4, the “Process Underwriting Request” activity 401 includes the sub-activities “Check Information Complete”, “Specify Missing Documents”, and “Check If Risk Assessment Needed”, the “Process Quote” activity 402 includes the sub-activity “Generate Quote”, and the “Issue Loan” activity” 405 includes the sub-activity “Download Documents.” The visual representation 400 indicates a typical process for the current outcome, including how long each activity, each sub-activity, and the overall process normally takes.

Selecting an activity or a sub-activity may provide the current worker with additional information. For example, FIG. 4 shows additional information presented to a worker in response to the worker selecting the “Generate Quote” sub-activity. The additional information may indicate, for example, the frequency (e.g., the percentage of cases) that the selected activity/sub-activity is executed, the average (e.g., mean) start/end times of the selected activity/sub-activity, and the most likely subsequent activity/sub-activity that will be performed after completion of the selected activity/sub-activity (e.g., via a percentage). The outcome with which an activity is correlated may be computed before the visual representation is rendered by counting, for a given outcome, the number of times that an activity occurs in a case instance which ends at that particular outcome.

Exemplary embodiments may utilize different visual indicators (e.g., shadings, hatchings, etc.) to indicate the likelihood of the occurrence of the displayed activities and sub-activities. For example, in FIG. 4, activities 401 and 402, as well as their corresponding sub-activities, have the darkest shading, indicating that they are likely to occur. Activities 403, 405, 406 and 408, as well as their corresponding sub-activities, have lighter shadings than activities 401 and 402, indicating that they are less likely to occur than activities 401 and 402. Activity 404 has a lighter shading than activities 403, 405, 406 and 408 and their corresponding sub-activities, indicating that it is less likely to occur than activities 403, 405, 406 and 408. Activity 407 has the lightest shading, indicating that it is the least likely activity in the visual representation 400 to occur.

The current worker may enable an option to overlay the current case being executed on the visual representation 400. The overlay indicates the status of the current case relative to the aggregate timeline. That is, the overlay indicates the status of each activity and sub-activity of the current case relative to the aggregate timeline, indicating to the current worker how quickly the current case is performing relative to similar previous cases. The overlay may include different colors indicating whether the corresponding activity or sub-activity is currently running or has been completed. For example, in FIG. 4, first and fourth portions 409 and 412 of an overlay may be illustrated in a first color indicating that the respective corresponding activity and sub-activity are currently being executed, and second and third portions 410 and 411 of the overlay may be illustrated in a second color indicating that the respective corresponding sub-activities have already been completed. In FIG. 4, the first portion 409 of the overlay indicates that the “Process Underwriting Request” activity 401 in the currently executed case has not yet reached the average time taken for this activity. The second and third portions 410 and 411 of the overlay indicate that the first two sub-activities of activity 401 have completed more quickly than the average completion time of these sub-activities. The fourth portion 412 of the overlay indicates that the third sub-activity of activity 401 began sooner than the average start time of this sub-activity, and is still currently being executed.

The overlay may also contain projected completion times for the case instance. For example, the overlay may show the projected completion time for a current case instance based on whether risk assessment is performed. For example, the projected completion time may be calculated by examining a set of completed case instances in which risk assessment was performed and a set of completed case instances in which risk assessment was not performed, and computing the average end-to-end completion time of each set.

Although the overlay shown in FIG. 4 indicates that the current case in this example is performing more quickly than the average, the overlay may also indicate that a current case is taking longer to complete than the average. That is, the overlay may indicate whether a certain activity or sub-activity is taking longer than the average, and may indicate whether the current case is stuck on a certain activity or sub-activity. In an example, a case worker (e.g., a supervisor) may be investigating reasons that a current case is in poor health (e.g., why a current case is taking longer than expected to complete). In this case, the supervisor may analyze the current case relative to other cases that are in good health (e.g., cases that are taking an expected, or an average amount of time to complete). This analysis may be done by analyzing an aggregate timeline compared to the current case to determine which activity or sub-activity of the current case is taking longer than the average amount of time for that respective activity or sub-activity in the previously executed cases that the aggregate timeline represents.

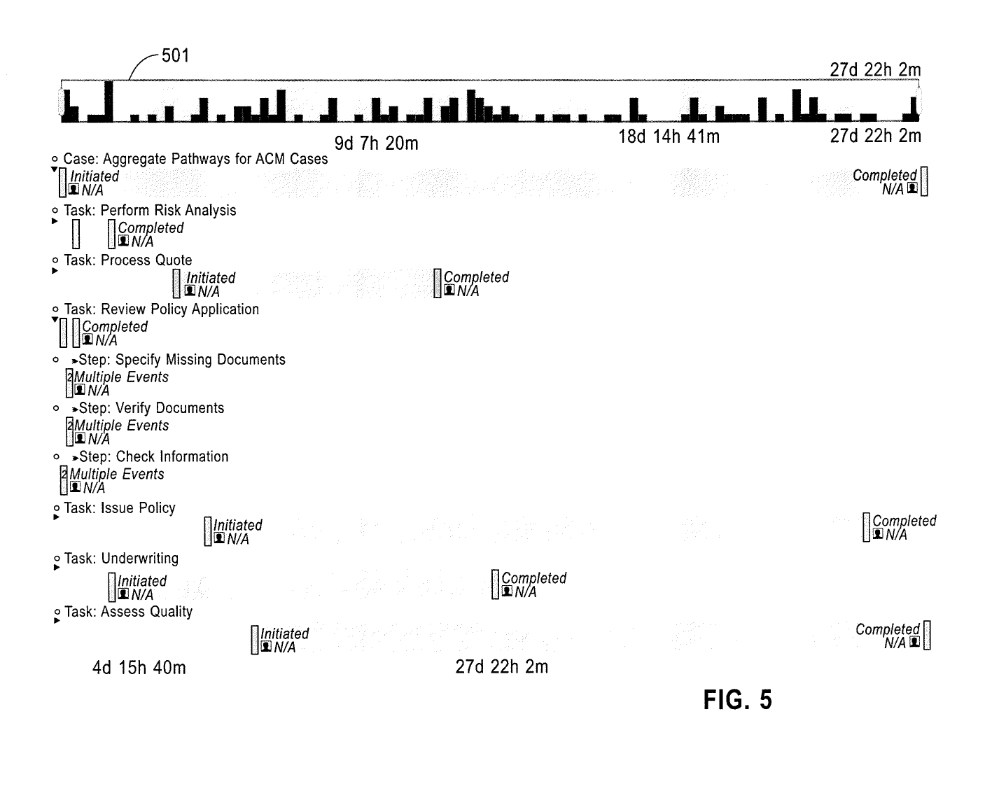

FIG. 5 shows an exemplary visual representation showing an aggregate timeline view providing information relating to the activities involved in reaching a case outcome with reference to the case model of FIG. 3, according to an exemplary embodiment of the present invention.

Similar to FIG. 4, FIG. 5 shows a generated visual representation 500 that shows an aggregate timeline view providing information relating to activities involved in reaching a case outcome. The visual representation 500 spans a set of previously completed case instances, and shows the activities performed in these case instances in time order along a horizontal axis. As shown in FIG. 5, the aggregate timeline view may include a timescale 501 indicating the total amount of time (e.g., in hours, days, weeks, etc.) that the aggregate timeline spans.

It is to be understood that exemplary embodiments of the present invention may be implemented in various forms of hardware, software, firmware, special purpose processors, or a combination thereof. In one embodiment, a method for achieving better case outcomes through the use of aggregate case histories may be implemented in software as an application program tangibly embodied on a computer readable storage medium or computer program product. As such the application program is embodied on a non-transitory tangible media. The application program may be uploaded to, and executed by, a processor comprising any suitable architecture.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various exemplary embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

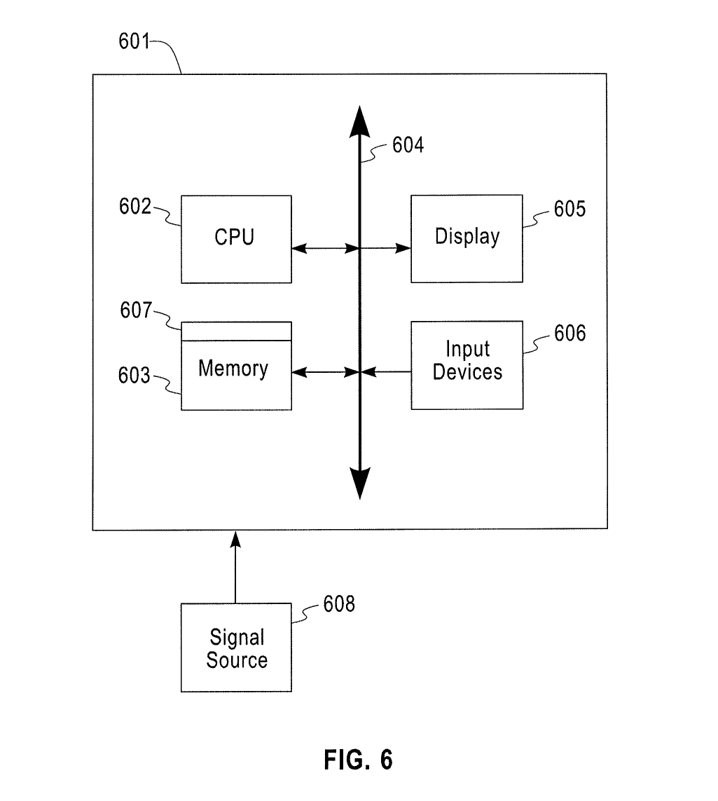

Referring to FIG. 6, according to an exemplary embodiment of the present invention, a computer system 601 for implementing aspects of the present invention can comprise, inter alia, a central processing unit (CPU) 602, a memory 603 and an input/output (I/O) interface 604. The computer system 601 is generally coupled through the I/O interface 604 to a display 605 and various input devices 606 such as a mouse and keyboard. The support circuits can include circuits such as cache, power supplies, clock circuits, and a communications bus. The memory 603 can include random access memory (RAM), read only memory (ROM), disk drive, tape drive, etc., or a combination thereof. The present invention can be implemented as a routine 607 that is stored in memory 603 and executed by the CPU 502 to process the signal from the signal source 608. As such, the computer system 601 is a general-purpose computer system that becomes a specific purpose computer system when executing the routine 607 of the present invention.

The computer platform 601 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described exemplary embodiments for a system and method for achieving better case outcomes through the use of aggregate case histories, it is noted that modifications and variations can be made by persons skilled in the art in light of the above teachings. It is therefore to be understood that changes may be made in exemplary embodiments of the invention, which are within the scope and spirit of the invention as defined by the appended claims. Having thus described the invention with the details and particularity required by the patent laws, what is claimed and desired protected by Letters Patent is set forth in the appended claims.

What is claimed is:

1. A method of case management, comprising:
receiving a plurality of previously executed case instances;
receiving a selection of current case attributes and at least one candidate case outcome during runtime of a currently executing case instance; and
generating a visual representation of case distributions using the previously executed case instances, wherein the visual representation depicts a correlation between the current case attributes and the at least one candidate case outcome, and the visual representation is generated using analytics applied to the plurality of previously executed case instances.

2. The method of claim 1, further comprising:
extracting results from a user interaction with the visual representation; and
applying the results to support execution of the currently executing case instance and future case instances.

3. The method of claim 1, wherein the selection of the current case attributes is dynamically changed during runtime of the currently executing case instance, and in response, the visual representation is automatically updated during runtime.

4. The method of claim 1, wherein the selection of the at least one candidate case outcome is dynamically changed during runtime of the currently executing case instance, and in response, the visual representation is automatically updated during runtime.

5. The method of claim 1, wherein the visual representation comprises a plurality of visualizations, and the plurality of visualizations are displayed in an order corresponding to a statistical significance of each of the plurality of visualizations.

6. The method of claim 1, wherein case attributes included in the currently executing case instance are highlighted in the visual representation.

7. The method of claim 1, wherein case attributes that are not included in the currently executing case instance are hidden in the visual representation.

8. The method of claim 1, further comprising pre-selecting the current case attributes based on the selected candidate outcome.

9. The method of claim 1, further comprising extracting a set of rules based on a user interaction with the visual representation, and implementing the set of rules to govern a manner in which steps invoked by a given task executes in a case model.

10. The method of claim 1, further comprising:
determining an activity present in each of the plurality of previously executed case instances for which the visual representation has been previously determined to be useful; and
generating an alert during execution of a future case instance indicating that the visual representation has been previously determined to be useful at the determined activity, upon the determined activity being executed in the future case instance.

11. The method of claim 1, wherein the visual representation comprises an indication of user input generated during the plurality of previously executed case instances.

12. The method of claim 11, wherein the user input comprises a user ranking indicating usefulness of a corresponding case attribute, or a user comment relating to the corresponding case attribute.

13. The method of claim 1, wherein the visual representation is dynamically generated during runtime of the currently executing case instance.

14. A method of case management, comprising:
receiving a plurality of previously executed case instances;
receiving a selection of a selected activity of a currently executing case instance; and
generating a visual representation comprising an aggregate timeline using the plurality of previously executed case instances,
wherein the visual representation depicts a sequence of a plurality of activities included in the plurality of previously executed case instances in time order,
wherein a first activity of the plurality of activities is the selected activity, and a last activity of the plurality of activities is a case outcome.

15. The method of claim 14, further comprising:
extracting results from a user interaction with the visual representation; and
applying the results to support execution of the currently executing case instance and future case instances.

16. The method of claim 14, wherein the selection of the selected activity is dynamically changed during runtime of the currently executing case instance.

17. The method of claim 14, wherein each of the plurality of activities depicts at least one of a minimum time to completion, a maximum time to completion, an average time to completion, an average start time, an average end time, and a median time to completion of the corresponding activity.

18. The method of claim 14, wherein each of the plurality of activities depicts at least one of a frequency of execution in a set of traces, a next activity or sub-activity to be executed, and an outcome determined to be highly correlated with the corresponding activity.

19. The method of claim 14, further comprising:
computing a normalized average start time for each of the plurality of activities with respect to a start time of the currently executing case instance; and
ordering the plurality of activities based on the normalized average start times.
